(19) United States
(12) Patent Application Publication
(10) Pub. No.: US 2019/0061771 A1
(43) Pub. Date: Feb. 28, 2019

(54) SYSTEMS AND METHODS FOR PREDICTING SENSOR INFORMATION

(71) Applicant: GM GLOBAL TECHNOLOGY OPERATIONS LLC, Detroit, MI (US)

(72) Inventors: Solomon Bier, San Francisco, CA (US); Elliot Branson, San Francisco, CA (US); Cody Neil, San Francisco, CA (US); Samuel Abrahams, San Francisco, CA (US); Nathan Mandi, San Francisco, CA (US); Daniel Johnson, San Francisco, CA (US); Haggai Nuchi, San Francisco, CA (US)

(73) Assignee: GM GLOBAL TECHNOLOGY OPERATIONS LLC, Detroit, MI (US)

(21) Appl. No.: 16/173,112

(22) Filed: Oct. 29, 2018

(51) Int. Cl. B60W 50/00; G05D 1/00; G05D 1/02; G06N 3/08; G06N 5/04; G06N 3/04

(52) U.S. Cl. CPC B60W 50/0097; G05D 1/0088; G05D 1/0221; B60W 2420/52; G06N 5/046; G06N 3/0454; G06N 3/08

(57) ABSTRACT

Systems and method are provided for controlling a vehicle. In one embodiment, a method of predicting sensor information of an autonomous vehicle includes: receiving point cloud data sensed from an environment associated with the vehicle; processing, by a processor, point cloud data with a convolutional neural network (CNN) to produce a set of segmentations stored in a set of memory cells; processing, by the processor, the set of segmentations of the CNN with a recurrent neural network (RNN) to predict future point cloud data; processing, by the processor, the future point cloud data to determine an action; and controlling the vehicle based on the action.

### TECHNICAL FIELD

The present disclosure generally relates to autonomous vehicles, and more particularly relates to systems and methods for predicting sensor information relating to an environment of an autonomous vehicle.

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle and perform traffic prediction.

While recent years have seen significant advancements in prediction systems, such systems might still be improved in a number of respects. For example, an autonomous vehicle will typically encounter, during normal operation, many vehicles and other objects, each of which might exhibit its own, hard-to-predict behavior. For example, some objects may not be visible or become temporarily invisible to the autonomous vehicle because they may be temporarily behind a building or another vehicle. Thus, making a prediction of future locations or trajectories of such objects difficult.

Accordingly, it is desirable to provide systems and methods that are capable of predicting future sensor information. It is further desirable to make use of the predicted sensor information for predicting object behavior and other information used in controlling the vehicle. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a vehicle. In one embodiment, a method of predicting sensor information of an autonomous vehicle and controlling the vehicle based thereon includes: receiving point cloud data sensed from an environment associated with the vehicle; processing, by a processor, point cloud data with a convolutional neural network (CNN) to produce a set of lidar segmentations stored in a set of memory cells; processing, by the processor, the set of lidar segmentations of the CNN with a recurrent neural network (RNN) to predict future point cloud data; processing, by the processor, the future point cloud data to determine an action; and controlling the vehicle based on the action.

In various embodiments, the method includes generating the point cloud data from a first sweep of a lidar sensor. In various embodiments, the first sweep is between 30 degrees and 180 degrees. In various embodiments, the future point cloud data corresponds to the first sweep.

In various embodiments, the recurrent neural network includes long short-term memory. In various embodiments, the recurrent neural network includes a gated recurrent unit.

In various embodiments, the processing the point cloud data with a CNN comprises processing the point cloud data with the CNN to determine spatial attributes.

In various embodiments, the processing the set of segmentations with the RNN comprises processing the set of segmentations with the RNN to determine temporal attributes.

In one embodiment, a system includes: a first non-transitory module configured to, by a processor, receive point cloud data sensed from an environment associated with the vehicle, and process the point cloud data with a convolutional neural network (CNN) to produce a set of segmentations stored in a set of memory cells; a second non-transitory module configured to, by a processor, process the set of segmentations of the CNN with a recurrent neural network (RNN) to predict future point cloud data; and a third non-transitory module configured to, by a processor, process the future point cloud data to determine an action, and control the vehicle based on the action.

In various embodiments, the first non-transitory module generates the point cloud data from a first sweep of a lidar sensor. In various embodiments, the first sweep is between 30 degrees and 180 degrees. In various embodiments, the future point cloud data corresponds to the first sweep.

In various embodiments, the recurrent neural network includes long short-term memory. In various embodiments, the recurrent neural network includes a gated recurrent unit.

In various embodiments, the second non-transitory module processes the point cloud data with the CNN by processing the point cloud data with the CNN to determine spatial attributes.

In various embodiments, the third non-transitory module processes the set of segmentations with the RNN by processing the set of segmentations with the RNN to determine temporal attributes.

In one embodiment, an autonomous vehicle is provided. The autonomous vehicle includes: a sensor system including a lidar configured to observe an environment associated with the autonomous vehicle; and a controller configured to, by a processor, receive point cloud data sensed from an environment associated with the vehicle, process the point cloud data with a convolutional neural network (CNN) to produce a set of lidar segmentations stored in a set of memory cells, process the set of lidar segmentations of the CNN with a recurrent neural network (RNN) to predict future point cloud data, and process the future point cloud data to determine an action, and control the vehicle based on the action.

In various embodiments, the controller generates the point cloud data from a first sweep of a lidar sensor, wherein the first sweep is between 30 degrees and 180 degrees, and wherein the future point cloud data corresponds to the first sweep.

In various embodiments, the recurrent neural network includes long short-term memory and a gated recurrent unit.

In various embodiments, the controller processes the point cloud data with the CNN by processing the point cloud data with the CNN to determine spatial attributes, and wherein the controller processes the set of segmentations with the RNN by processing the set of segmentations with the RNN to determine temporal attributes.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a prediction system, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a dataflow diagram illustrating a sensor information prediction module, in accordance with various embodiments;

FIG. 5 is a functional block diagram illustrating a neural network of the sensor information prediction module, in accordance with various embodiments; and

FIG. 6 is a flowchart illustrating a control method for controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein are merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

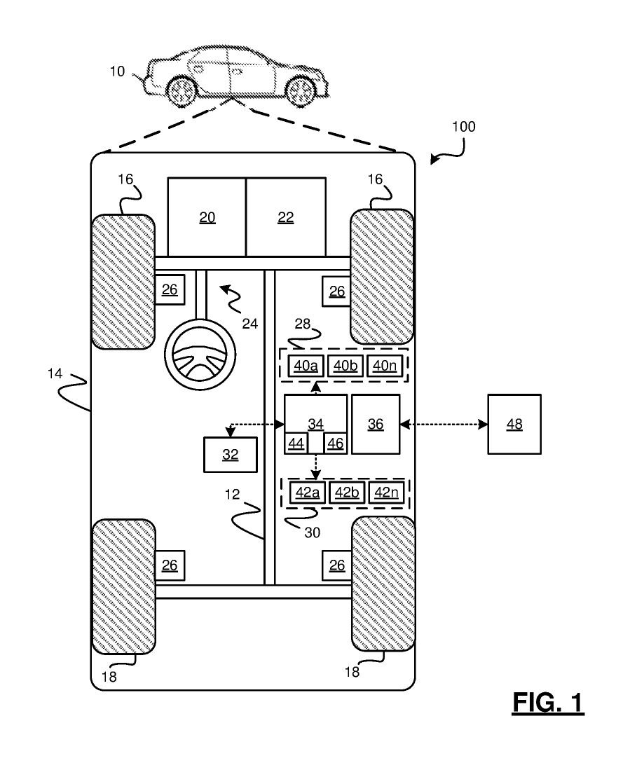

With reference to FIG. 1, a prediction system shown generally as 100 is associated with a vehicle 10 in accordance with various embodiments. In general, the prediction system (or simply “system”) 100 is configured to predict future sensor information associated with the environment of the vehicle 10. In various embodiments, the prediction system 100 observes both spatial attributes and temporal attributes using a combination of trained neural networks in order to predict the future sensor information. The vehicle 10 is thereafter controlled based on the predicted future sensor information.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the prediction system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n might include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

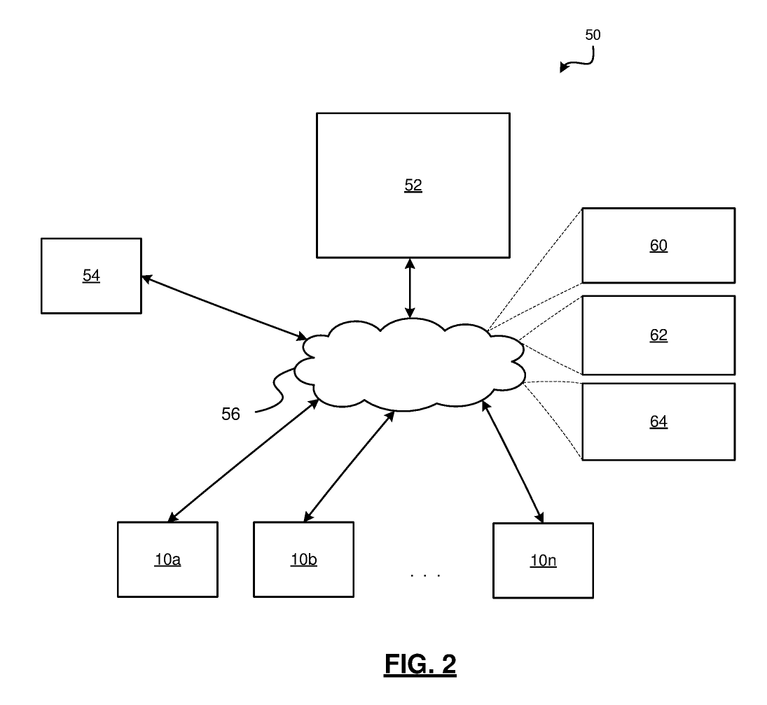

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10. In one embodiment, as discussed in detail below, the controller 34 is configured to predict future sensor information relating to an environment in the vicinity of the AV 10 and control the AV 10 based thereon.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information. In one embodiment, as described in further detail below, remote transportation system 52 includes a route database 53 that stores information relating to navigational system routes and also may be used to perform traffic pattern prediction.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

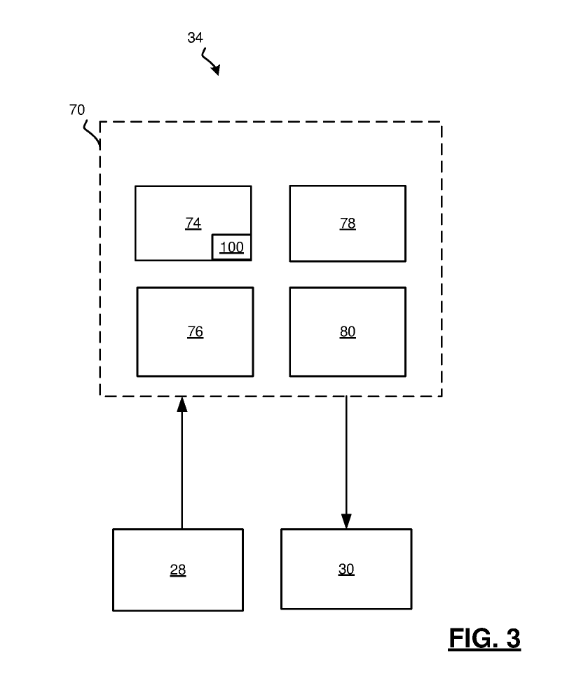

In accordance with various embodiments, the controller 34 implements an autonomous driving system (ADS) 70 as shown in FIG. 3. That is, suitable software and/or hardware components of the controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, the prediction system 100 is configured to predict sensor information associated with the environment in the vicinity of the AV 10 and iteratively improve those predictions over time based on its observations within the environment. In some embodiments, this functionality is incorporated into computer vision system 74 of FIG. 2.

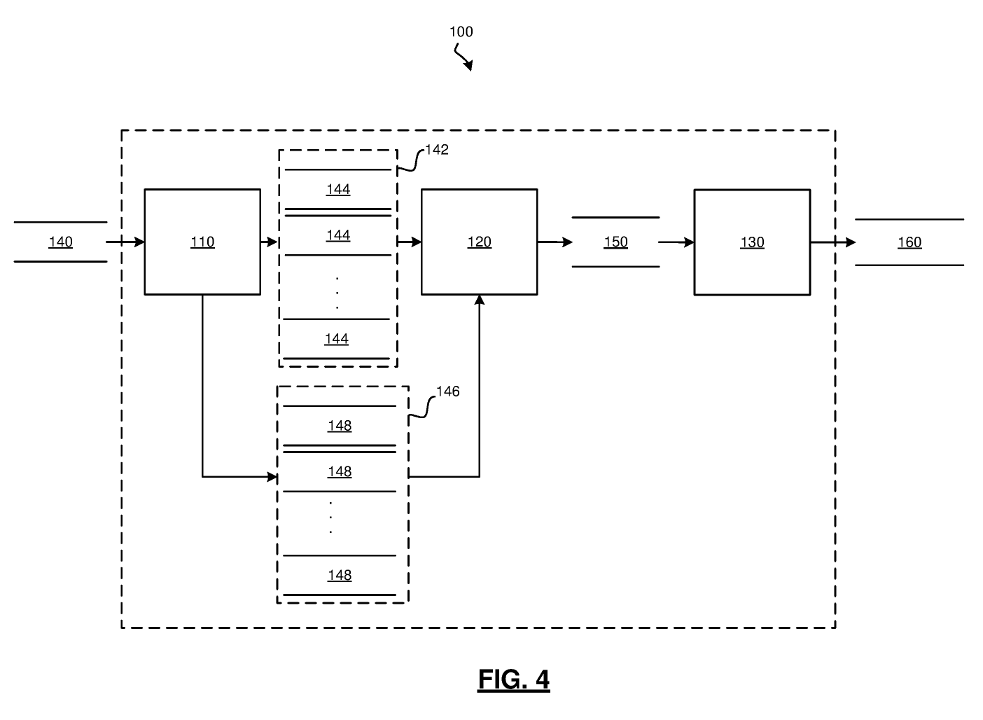

In that regard, FIG. 4 is a dataflow diagram illustrating aspects of the prediction system 100 in more detail. It will be understood that the sub-modules shown in FIG. 4 can be combined and/or further partitioned to similarly perform the functions described herein. Inputs to modules may be received from the sensor system 28, received from other control modules (not shown) associated with the autonomous vehicle 10, received from the communication system 36, and/or determined/modeled by other sub-modules (not shown) within the controller 34 of FIG. 1.

As shown, the prediction system 100 may include a spatial dependency processing module 110, a temporal dependency processing module 120, and an action determination module 130. In various embodiments, the modules 110-130 may be implemented using any desired combination of hardware and software. In some embodiments, the modules implement a global network comprising a combination of a number of machine learning (ML) models. As discussed in more detail below, in the exemplary embodiments shown, the machine learning models include a combination of artificial neural networks (ANNs). As can be appreciated, in other exemplary embodiments a variety of other machine learning techniques may be employed (and not discussed herein), including, for example, multivariate regression, random forest classifiers, Bayes classifiers (e.g., naive Bayes), principal component analysis (PCA), support vector machines, linear discriminant analysis, clustering algorithms (e.g., KNN, K-means), and/or the like. By implementing both a spatial dependency processing module 10 and a temporal dependency processing module 120, the system 100 is able to predict the sensor information even when objects may become occluded temporarily.

As shown in FIG. 4, the spatial dependency processing module 110 receives available sensor data 140, such as, lidar data or in alternative embodiments, camera data. The lidar data can include, for example, point cloud data from a first sweep (e.g., a sweep ranging between 30 degrees and 180 degrees, or any degrees) of a lidar sensor.

The spatial dependency processing module 110 processes the sensor data 140 to determine one or more entities within the environment and kinematic attributes (e.g., a visual path and trajectory) of those entities. In order to determine the set of entities, the spatial dependency processing module implements, for example, a convolutional neural network (CNN). The CNN may be trained in a supervised or unsupervised manner to identify and label the different entities. As used herein the term “entities” refers to other vehicles, bicycles, objects, pedestrians, or other moving or non-moving elements within an environment.

When the sensor data 140 includes lidar data, the convolutional neural network identifies the environment including the entity and generates as set 146 of lidar segmentations 148 containing the identified environment. The spatial dependency processing module 110 saves the set 146 of lidar segmentations 148 in the set of memory cells.

When the sensor data 140 includes camera data, the convolutional neural network identifies the environment including the entity and generates as output a set 142 of image frames 144 containing the identified environment. The spatial dependency processing module 110 saves the set 142 of related frames 144 in, for example, a set of memory cells. In various embodiments, the sets 142, 146 include 120 or some other number of frames or segmentations.

The temporal dependency processing module 120 receives the set of data 142 and/or 146 (containing the related frames 144 and/or containing the lidar segmentations 148) stored in the memory cells and that were populated by the spatial dependency processing module 110. The temporal dependency processing module 120 processes the set of data 142 and/or 146 to predict a future state 150 of the environment identified in the set of cells (e.g., what to expect will happen over the next X seconds).

In order to predict the future state 150, the temporal dependency processing module 120 implements, for example, a gated recurrent neural network (RNN) such as a long short-term memory (LSTM) or a gated recurrent unit (GRU) to predict the future state 150. In various embodiments, when the set of data 146 includes lidar segmentations 148, the future state 150 includes a predicted future point cloud. In various embodiments, the future point cloud data corresponds to the initial sweep. In various embodiments, when the set of data 142 includes camera frames 144, the future state 150 includes a predicted future frame.

The action determination module 130 receives the predicted future state 150 of the environment and determines an action 160. In various embodiments, the action 160 may include a state machine including commit logic and/or yield logic for certain vehicle maneuvers. The vehicle 10 is thereafter controlled based on the action 160.

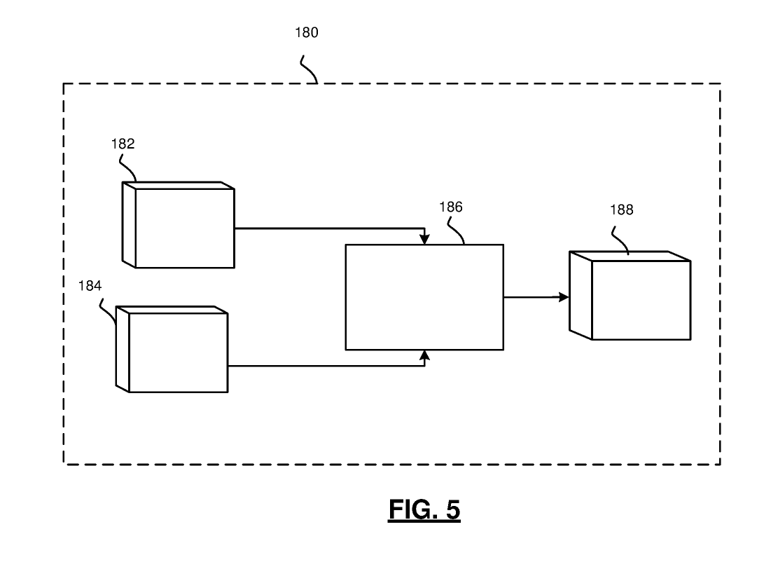

FIG. 5 illustrates aspects of the prediction system 100 in more detail. FIG. 5 illustrates a combination of trained neural networks 180 that may be used by the prediction system 100 in accordance with various embodiments. As shown, a layer N 182, and a layer N+1 184 of a convolutional neural network are fed into a recurrent neural network 184 to produce a layer N+1 188. This combination is performed for each time step to produce the predicted states.

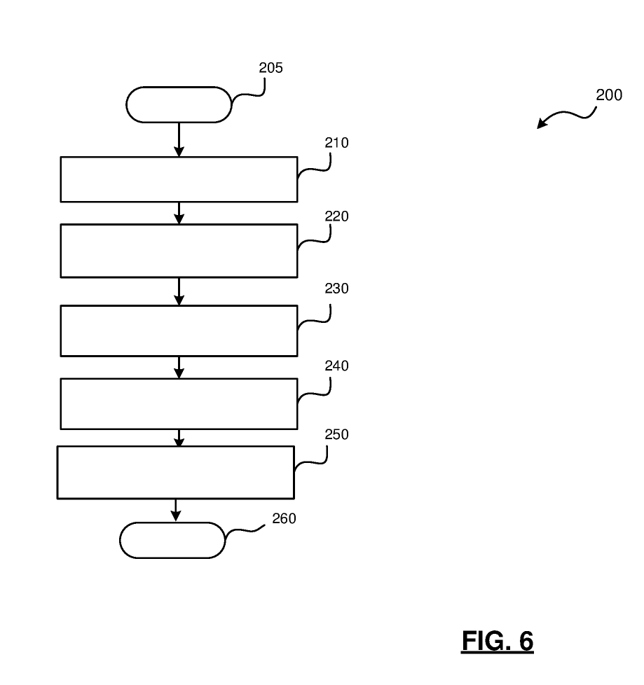

Referring now to FIG. 6, and with continued reference to FIGS. 1-5, a flowchart illustrates a control method 200 that can be performed by the system 100 in accordance with the present disclosure. As can be appreciated in light of the disclosure, the order of operation within the method is not limited to the sequential execution as illustrated in FIG. 6, but may be performed in one or more varying orders as applicable and in accordance with the present disclosure. In various embodiments, the method 200 can be scheduled to run based on one or more predetermined events, and/or can run continuously during operation of the autonomous vehicle 10.

In one example, the method 200 may begin at 205. The sensor data 140 is received at 210. The sensor data is processed with, for example, a CNN to determine entities and spatial relationships between the entities at 220, for example, as discussed above. A result of the processing at 220 includes a plurality of frames or lidar segmentations that are stored in memory cells. The result is then processed at 230 with a gated RNN to determine temporal dependencies of the environment and to predict a future state or states of the environment, for example, as discussed above. The future state or states is then used to determine one or more possible actions at 240, for example, as discussed above. The vehicle 10 is then controlled based on the action at 250. Thereafter, the method may end at 260.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle, comprising:
receiving point cloud data sensed from an environment associated with the vehicle;
processing, by a processor, point cloud data with a convolutional neural network (CNN) to produce a set of segmentations stored in a set of memory cells;
processing, by the processor, the set of segmentations of the CNN with a recurrent neural network (RNN) to predict future point cloud data;
processing, by the processor, the future point cloud data to determine an action; and
controlling the vehicle based on the action.

2. The method of claim 1, further comprising generating the point cloud data from a first sweep of a lidar sensor.

3. The method of claim 2, wherein the first sweep is between 30 degrees and 180 degrees.

4. The method of claim 3, wherein the future point cloud data corresponds to the first sweep.

5. The method of claim 1, wherein the recurrent neural network includes long short-term memory.

6. The method of claim 5, wherein the recurrent neural network includes a gated recurrent unit.

7. The method of claim 1, wherein the processing the point cloud data with a CNN comprises processing the point cloud data with the CNN to determine spatial attributes.

8. The method of claim 1, wherein the processing the set of segmentations with the RNN comprises processing the set of segmentations with the RNN to determine temporal attributes.

9. A computer implemented system for controlling a vehicle, comprising:
a first non-transitory module configured to, by a processor, receive point cloud data sensed from an environment associated with the vehicle, and process the point cloud data with a convolutional neural network (CNN) to produce a set of segmentations stored in a set of memory cells;
a second non-transitory module configured to, by a processor, process the set of segmentations of the CNN with a recurrent neural network (RNN) to predict future point cloud data; and
a third non-transitory module configured to, by a processor, process the future point cloud data to determine an action, and control the vehicle based on the action.

10. The computer implemented system of claim 9, wherein the first non-transitory module generates the point cloud data from a first sweep of a lidar sensor.

11. The computer implemented system of claim 10, wherein the first sweep is between 30 degrees and 180 degrees.

12. The computer implemented system of claim 11, wherein the future point cloud data corresponds to the first sweep.

13. The computer implemented system of claim 9, wherein the recurrent neural network includes long short-term memory.

14. The computer implemented system of claim 13, wherein the recurrent neural network includes a gated recurrent unit.

15. The computer implemented system of claim 9, wherein the second non-transitory module processes the point cloud data with the CNN by processing the point cloud data with the CNN to determine spatial attributes.

16. The computer implemented system of claim 9, wherein the third non-transitory module processes the set of segmentations with the RNN by processing the set of segmentations with the RNN to determine temporal attributes.

17. An autonomous vehicle comprising:
a sensor system including a lidar configured to observe an environment associated with the autonomous vehicle; and
a controller configured to, by a processor, receive point cloud data sensed from an environment associated with the vehicle, process the point cloud data with a convolutional neural network (CNN) to produce a set of segmentations stored in a set of memory cells, process the set of segmentations of the CNN with a recurrent neural network (RNN) to predict future point cloud data, process the future point cloud data to determine an action, and control the vehicle based on the action.

18. The autonomous vehicle of claim 17, wherein the controller generates the point cloud data from a first sweep of a lidar sensor, wherein the first sweep is between 30 degrees and 180 degrees, and wherein the future point cloud data corresponds to the first sweep.

19. The autonomous vehicle of claim 17, wherein the recurrent neural network includes long short-term memory and a gated recurrent unit.

20. The autonomous vehicle of claim 17, wherein the controller processes the point cloud data with the CNN by processing the point cloud data with the CNN to determine spatial attributes, and wherein the controller processes the set of segmentations with the RNN by processing the set of segmentations with the RNN to determine temporal attributes.
